(19) United States
(12) Patent Application Publication
(10) Pub. No.: US 2017/0073029 A1
(43) Pub. Date: Mar. 16, 2017

(54) PROTECTIVE HAND COVERING

(71) Applicant: Wolf Tooth Components, LLC, Savage, MN (US)

(72) Inventors: Michael W. Pfeiffer, Savage, MN (US); Brendan J. Moore, Prior Lake, MN (US); Daniel D. Dittmer, Shakopee, MN (US); Jack W. Hinkens, Eden Prairie, MN (US)

(21) Appl. No.: 15/266,844

(22) Filed: Sep. 15, 2016

Related U.S. Application Data
(60) Provisional application No. 62/219,074, filed on Sep. 15, 2015.

(51) Int. Cl. B62J 17/00

(52) U.S. Cl. CPC B62J 17/00; B60Y 2200/13

(57) ABSTRACT

A protective hand covering to be attached to a handlebar includes a shell to cover a portion of the handlebar, with the shell forming a cavity and having a cuff extending therefrom such that a break in the cuff is to be closed to establish a first configuration of the protective hand covering, such that the break in the cuff is to be opened to establish a second configuration of the protective hand covering, and such that the break in the cuff is to be opened and the cuff is to be folded to establish a third configuration of the protective hand covering.

### CROSS-REFERENCE TO RELATED APPLICATIONS

This application claims priority under 35 U.S.C. §119(e) to U.S. Provisional Patent Application Ser. No. 62/219,074 filed on Sep. 15, 2015, and incorporated herein by reference.

### BACKGROUND

The present disclosure relates generally to a handlebar accessory and, more specifically, relates to a protective hand covering to be attached or secured to a handlebar to cover and protect a user's hand from, for example, precipitation (e.g., rain, sleet, snow), wind, and/or cold.

### BRIEF DESCRIPTION OF THE DRAWINGS

FIG. 1 is a side view of one example of a portion of a bicycle including one example of a portion of a handlebar for the bicycle.

FIG. 2 is a side view of one example of a protective hand covering in accordance with the present disclosure.

FIG. 3 is a medial view of one example of the protective hand covering of FIG. 2 secured to the handlebar of FIG. 1.

FIG. 4 is a rear view of the protective hand covering of FIG. 3.

FIG. 5 is a lateral view of the protective hand covering of FIG. 3.

FIG. 6 is a front view of the protective hand covering of FIG. 3.

FIG. 7 is an enlarged view of one example of the protective hand covering of FIG. 3 in a configuration including a closed cuff.

FIG. 8 is an enlarged view of one example of the protective hand covering of FIG. 3 in another configuration including an open cuff.

FIG. 9 is an enlarged view of one example of the protective hand covering of FIG. 3 in another configuration including a folded cuff.

FIG. 9A is one example of a schematic cross-sectional view from the perspective of line A-A of FIG. 9.

FIG. 10 is a medial view of one example of the protective hand covering of FIG. 9 secured to the handlebar of FIG. 1.

FIG. 11 is a rear view of the protective hand covering of FIG. 10.

FIG. 12 is a lateral view of the protective hand covering of FIG. 10.

FIG. 13 is a front view of the protective hand covering of FIG. 10.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

Riding a bicycle during inclement weather conditions, for example, during cold and/or wet conditions, may result in cold and/or wet hands of the rider. While wearing gloves may be useful to protect a rider's hands during inclement weather conditions, such gloves may become cold and/or wet themselves. In addition, such gloves may limit grip and/or dexterity of the rider's hands and/or finger or fingers. Accordingly, the present disclosure provides a protective hand covering to be attached or secured to a handlebar of a bicycle to cover or protect the rider's hands during, for example, cold and/or wet conditions.

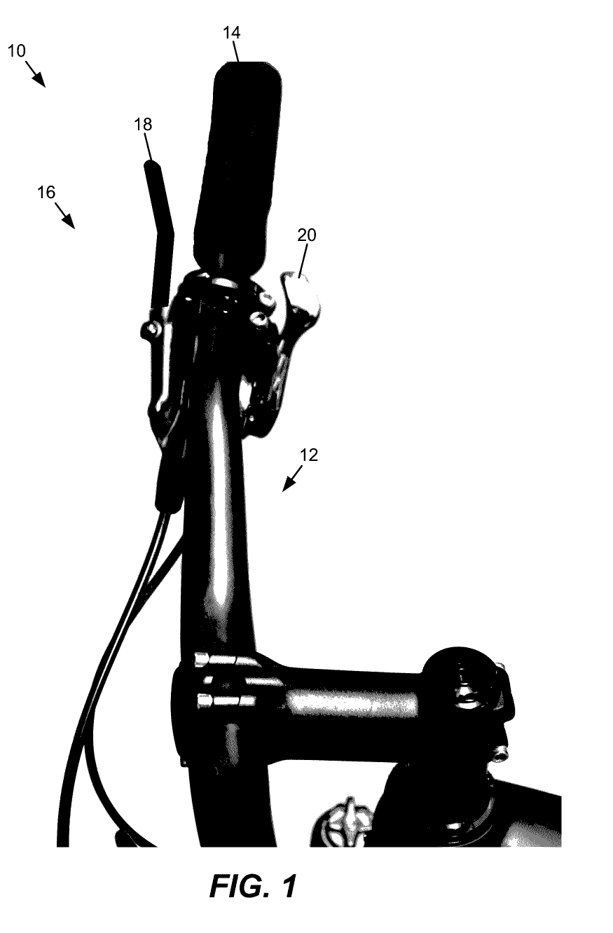

FIG. 1 is a side view of one example of a portion of a bicycle 10, including one example of a portion of a handlebar 12 for bicycle 10. In some examples, handlebar 12 includes a handlebar grip 14 to be held or gripped by a user while riding bicycle 10, and includes one or more bicycle controls 16, including, for example, a brake control, such as brake lever 18 and/or a gear control, such as gear shifter 20. In other examples, handlebar grip 14 and/or one or more of bicycle controls 16, such as brake lever 18 and/or gear shifter 20, may be excluded.

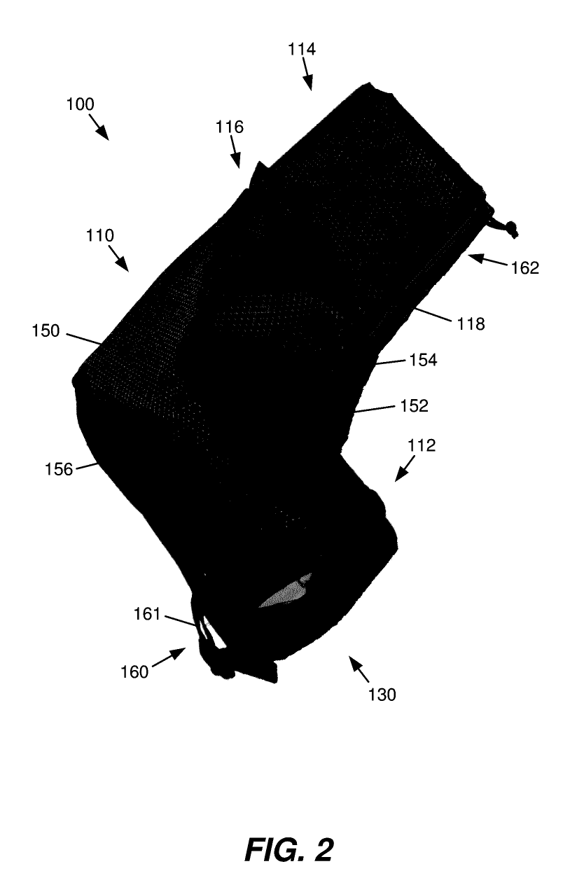

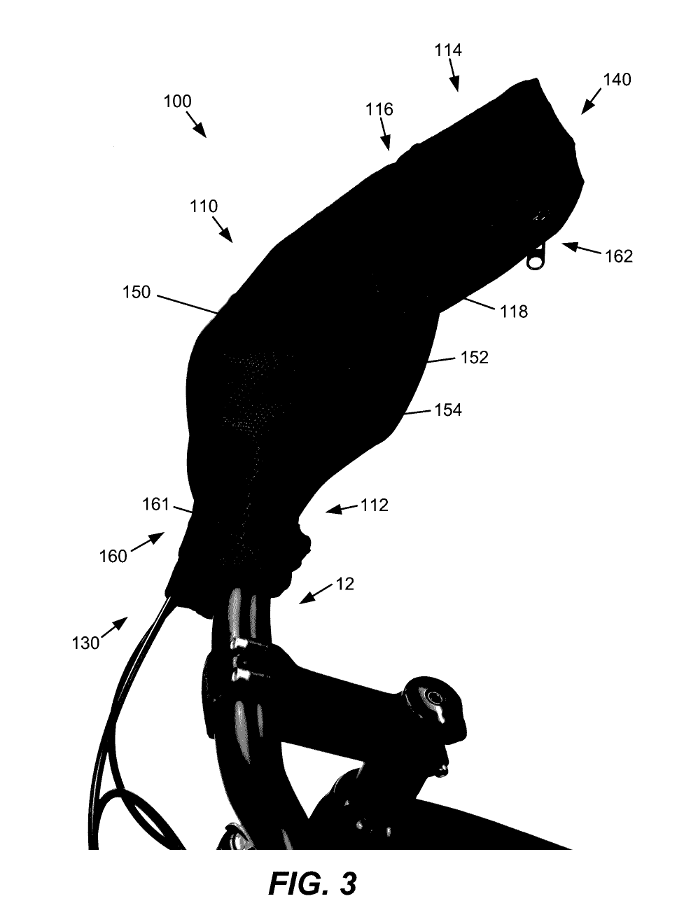

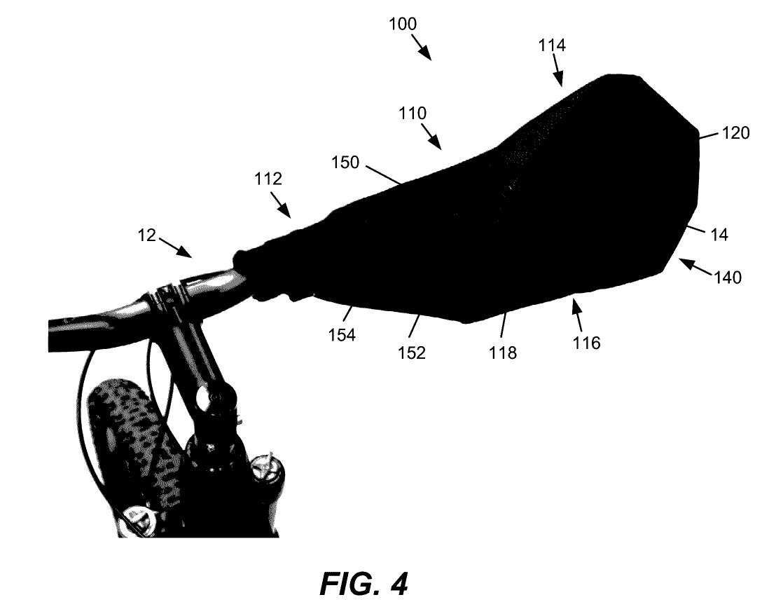

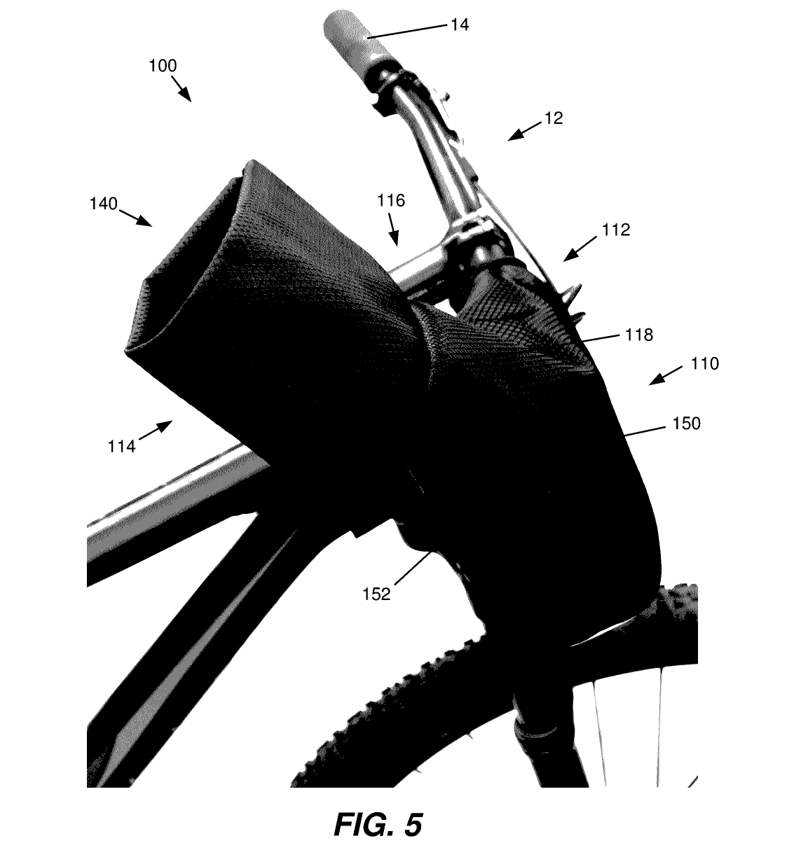

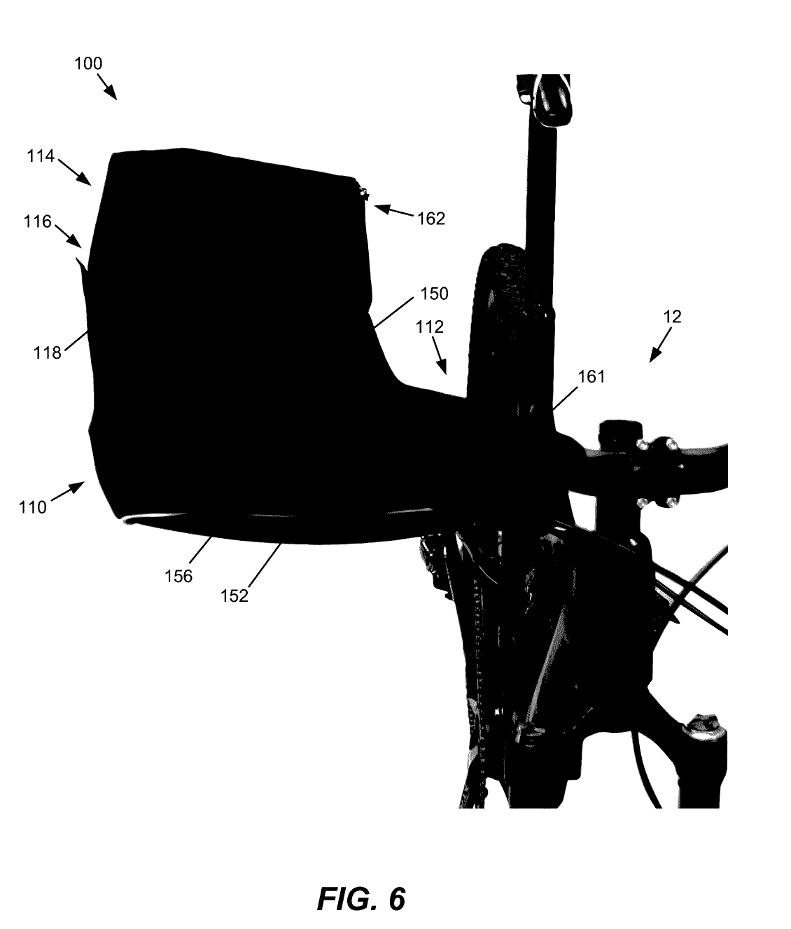

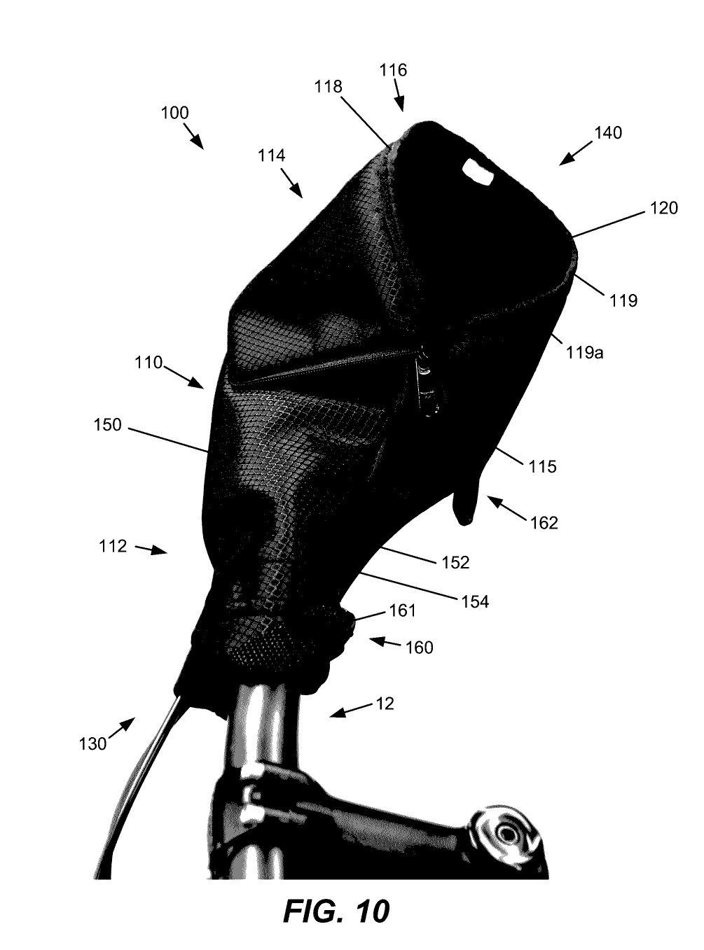

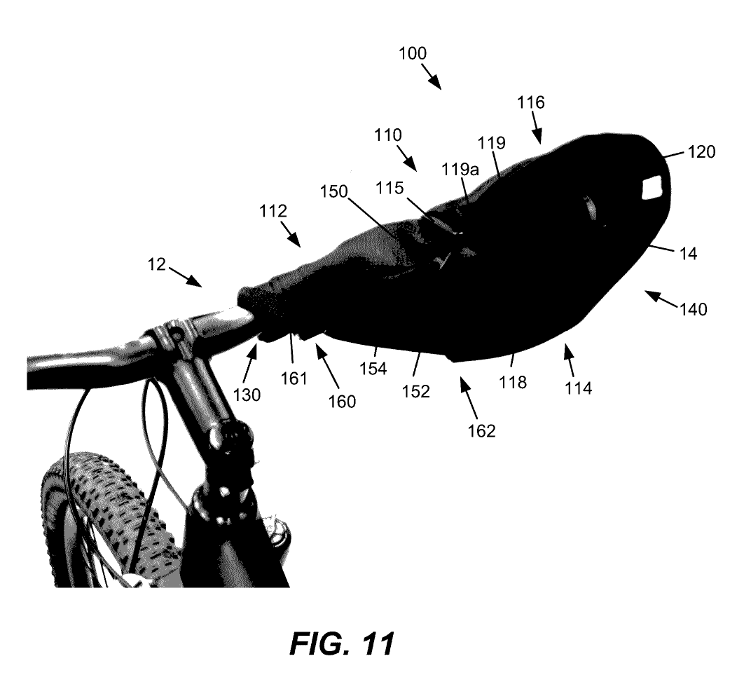

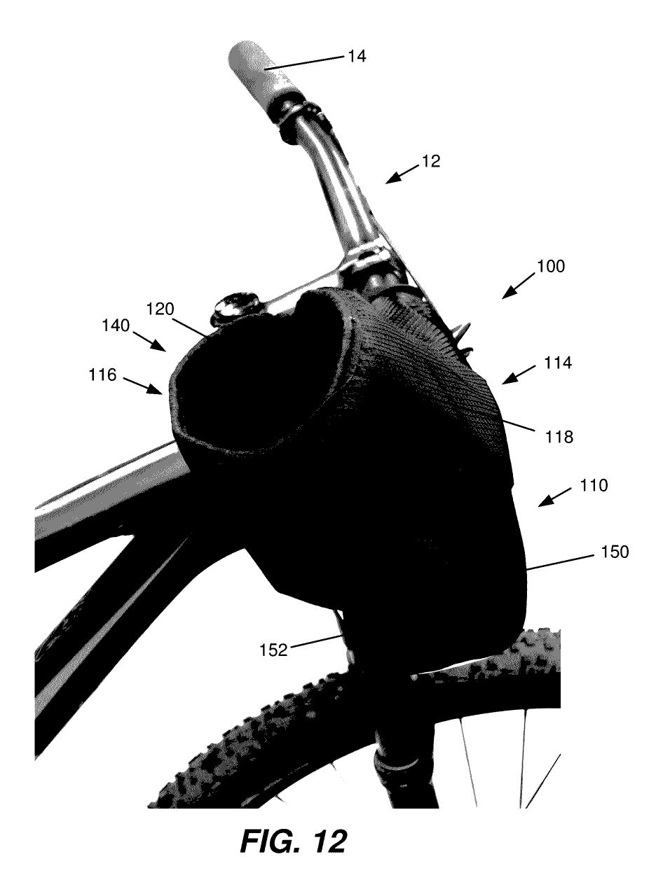

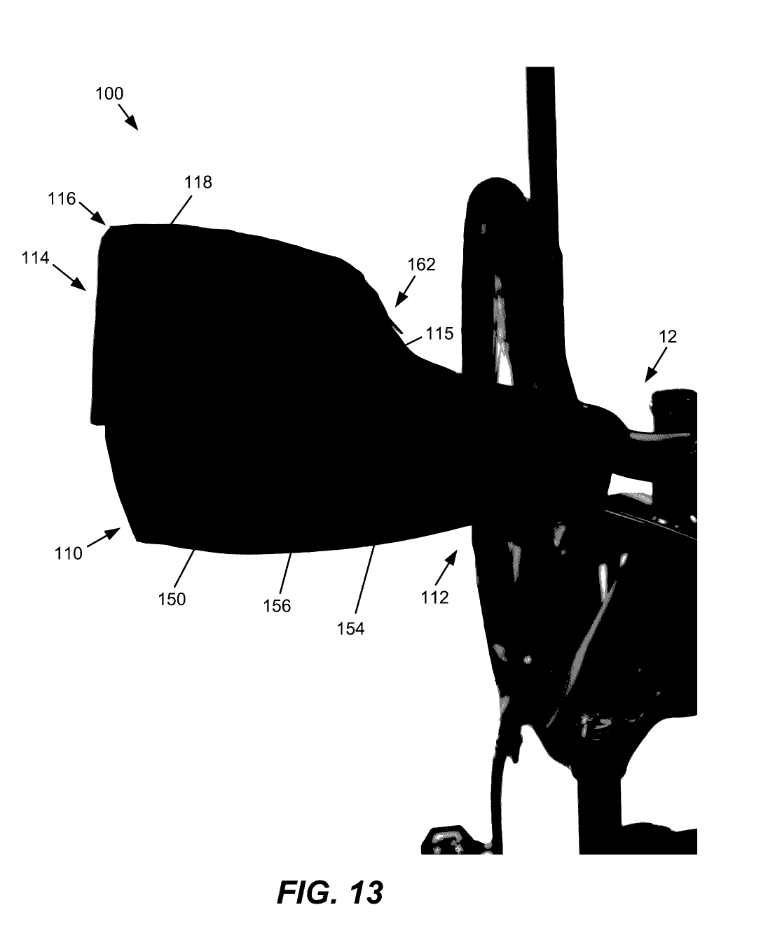

FIG. 2 is a side view of one example of a protective hand covering 100. In addition, FIGS. 3-6 and 10-13 are views of one example of protective hand covering 100 attached or secured to handlebar 12. As illustrated in FIGS. 2-6 and 10-13, protective hand covering 100 includes a pod or shell 110 which defines or forms a pocket or cavity 120 sized and configured to cover handlebar grip 14 and bicycle controls 16, and receive the rider's hand to allow the rider to steer bicycle 10 with handlebar 12 and operate bicycle controls 16 while the rider's hand is protected or covered by shell 110.

In one example, protective hand covering 100 includes a handlebar opening 130 to facilitate installation on handlebar 12 and accommodate wires, cables, housings, and/or hoses which connect, for example, to bicycle controls 16. As such, handlebar opening 130 receives and encircles a portion of handlebar 12, and has wires, cables, housings, and/or hoses extended or routed therethrough. In addition, protective hand covering 100 includes a hand opening 140 to facilitate insertion of the rider's hand into and removal of the rider's hand from cavity 120.

In one example, shell 110 includes an extended portion or neck 112 with handlebar opening 130 formed therein or provided thereby, and an extended portion or cuff 114 with hand opening 140 formed therein or provided thereby. In examples, cuff 114 is selectively closed, opened, and/or folded to facilitate different configurations of protective hand covering 100 including, more specifically, different configurations of cuff 114, as described below.

In one example, neck 112 includes an adjustable closure 160 to adjust (e.g., open, close, increase, decrease) handlebar opening 130. For example, adjustable closure 160 may be loosened to increase handlebar opening 130 and facilitate installation of protective hand covering 100 on handlebar 12, and/or may be tightened to reduce handlebar opening 130 and generally conform and hold neck 112 in place around handlebar 12. In one example, adjustable closure 160 includes a compression or cinch strap 161. In other examples, adjustable closure 160 may include, for example, a zipper, corresponding hook and loop fasteners, snaps, buttons, buckles, magnets, etc.

In one example, shell 110 includes a top panel 150 and a bottom panel 152 fit together to form cavity 120 therebetween. In one example, top panel 150 and bottom panel 152 are formed of a single panel folded over onto itself and joined together along a medial seam 154 and a bottom seam 156. In another example, top panel 150 and bottom panel 152 may be formed of separate panels laid over each other and joined together along a medial seam, a lateral seam, and a bottom seam. The seams may be formed, for example, by stitching, gluing, welding, heat sealing, or other.

In one example, a fold line 116 is formed or provided at a base of cuff 114 to facilitate different configurations of protective hand covering 100, including, more specifically, different configurations of cuff 114, as described below. In one example, fold line 116 is formed by a circumferential seam 118 extended around (or substantially around) cuff 114. In one example, circumferential seam 118 joins cuff 114 to top panel 150 and bottom panel 152. In one implementation, circumferential seam 118 includes an inverted seam, as described below.

In one example, cuff 114 is formed of a single panel folded over onto itself and joined to top panel 150 and bottom panel 152 along circumferential seam 118. In another example, cuff 114 may be formed of two (or more than two) panels laid over each other and joined to top panel 150 and bottom panel 152 along a circumferential seam and joined together (at least) along a lateral seam. The seams may be formed, for example, by stitching, gluing, welding, heat sealing, or other.

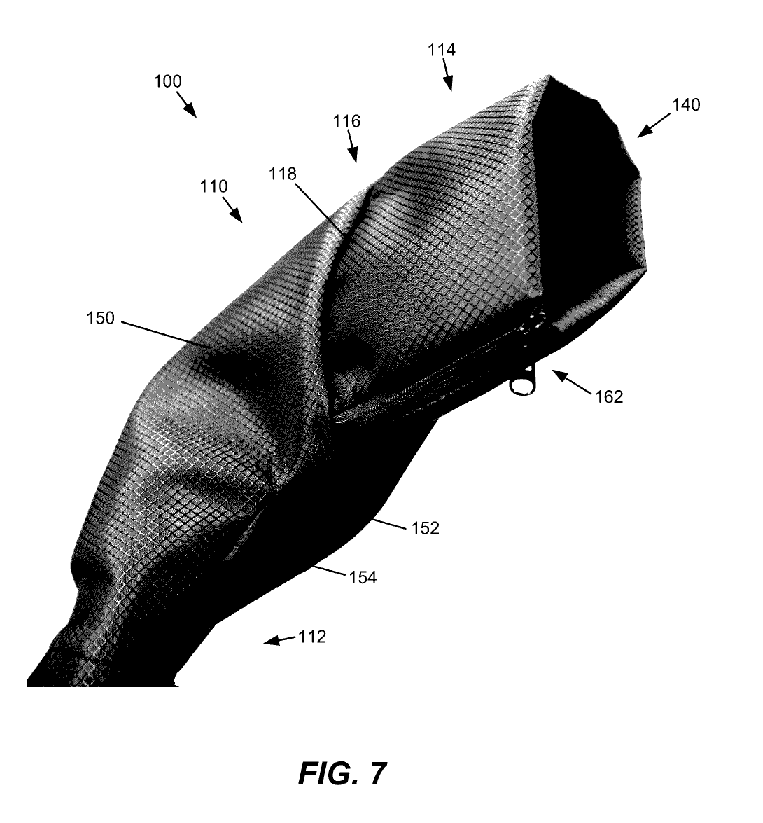

In one example, as illustrated in FIGS. 7, 8, and 9, cuff 114 is a split cuff and includes a break or split 115 along a medial side thereof. In one example, split 115 is formed along or extended (generally) from medial seam 154. In one example, split 115 facilitates different configurations of protective hand covering 100 including, more specifically, different configurations of cuff 114, as described below.

In one example, cuff 114 includes a zipper 162 along split 115 to facilitate closing and opening of cuff 114. In other examples, other manners of closing and opening of cuff 114 may be provided including, for example, corresponding hook and loop fasteners, snaps, straps, buttons, buckles, magnets, etc.

In one example, protective hand covering 100, including shell 110 (viz., top panel 150 and bottom panel 152) and cuff 114, is formed of one or more layers of weather proof, water proof, wind proof, weather resistant, water resistant, wind resistant, and/or insulating material, and may include, for example, an outer layer, inner layer, and/or intermediate layer. Example materials for protective hand covering 100 include nylon fabric, rip-stop nylon, polyester, neoprene, foamed neoprene, and/or fleece or coated fleece.

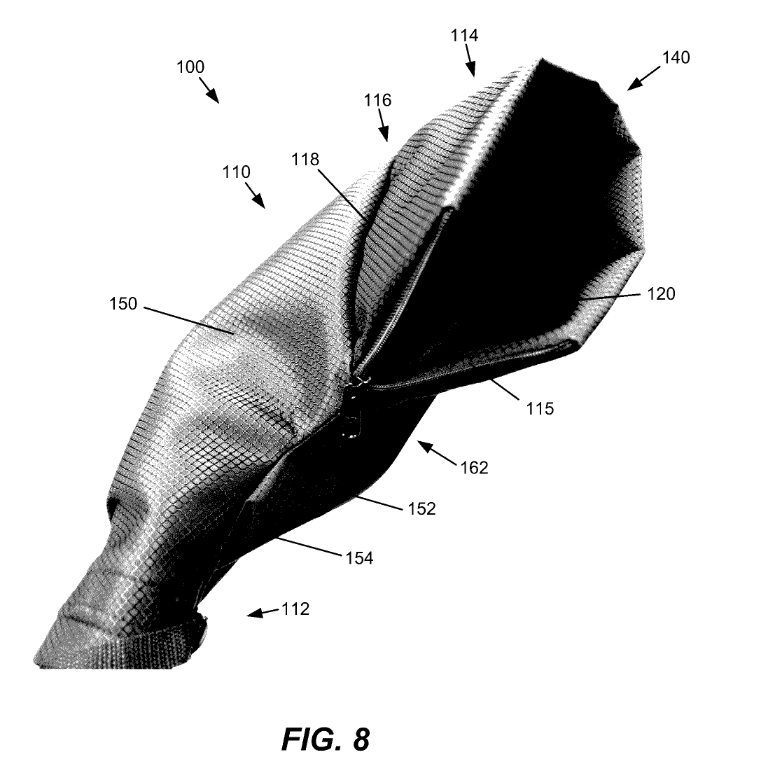

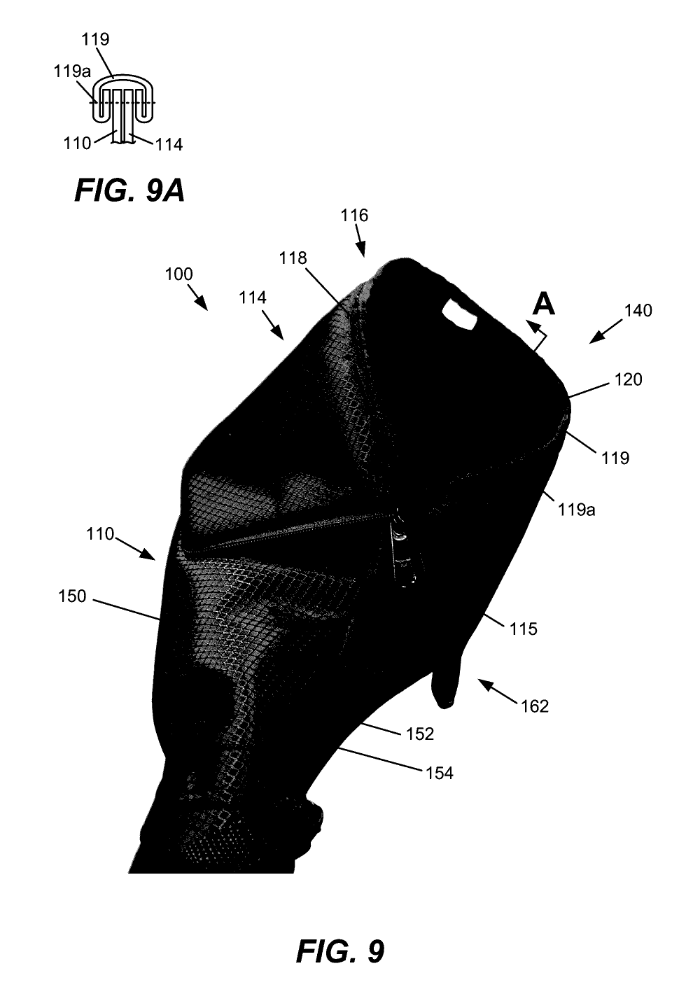

In one example, as illustrated in FIGS. 7, 8, and 9, protective hand covering 100 provides different configurations including, more specifically, different configurations of cuff 114. For example, FIG. 7 illustrates an example of protective hand covering 100 in a first configuration with cuff 114 in a closed configuration, FIG. 8 illustrates an example of protective hand covering 100 in a second configuration with cuff 114 in an open configuration, and FIG. 9 illustrates an example of protective hand covering 100 in a third configuration with cuff 114 in a folded configuration.

More specifically, with the closed configuration of FIG. 7, split 115 is closed (including at least substantially closed) such that cuff 114 provides a closed cuff for protective hand covering 100. In addition, with the open configuration of FIG. 8, split 115 is open (including at least partially or substantially open) such that cuff 114 provides an open cuff for protective hand covering 100. Furthermore, with the folded configuration of FIG. 9, split 115 is open (including at least substantially open) such that cuff 114 provides a folded cuff for protective hand covering 100.

In one example, the folded configuration of FIG. 9 is established by folding cuff 114 over top panel 150 and bottom panel 160. In one example, cuff 114 is folded along fold line 116 as formed, for example, by circumferential seam 118 at a base of cuff 114. In one example, as schematically illustrated in FIG. 9A, circumferential seam 118 includes an inverted seam finished with binding strip 119 and stitched with stitching 119a to create a bound seam.

FIGS. 2-6 and 7 illustrate one example of protective hand covering 100 with cuff 114 in the closed configuration, FIG. 8 illustrates one example of protective hand covering 100 with cuff 114 in the open configuration, and FIGS. 9 and 10-13 illustrate one example of protective hand covering 100 with cuff 114 in the folded configuration. The different configurations of cuff 114 provide different levels of coverage or protection to a user's hand. For example, with the closed configuration of FIGS. 2-6 and 7, cuff 114 encircles and extends over the wrist and at least partially up the forearm of the user. In addition, with the open configuration of FIG. 8, cuff 114 partially encircles and partially extends over the wrist and at least partially up the forearm of the user. Furthermore, with the folded configuration of FIGS. 9 and 10-13, cuff 114 extends to a lesser extent or is excluded from extending up the forearm of the user. Accordingly, in all configurations, the user's hand and/or wrist and/or partial forearm are covered and protected, while enabling access to, in one example, handlebar 12 (including handlebar grip 14) and, in some examples, bicycle controls 16.

In one example, with the folded configuration of FIGS. 9 and 10-13, cuff 114 provides an additional layer of protection or covering for the user's hand, since cuff 114 is folded over top panel 150 and bottom panel 152. In one example, with the folded configuration of FIGS. 9 and 10-13, cuff 114 and, in one example, cuff 114 in combination with circumferential seam 118, provides additional structural support to protective hand covering 100 including, more specifically, shell 110 to establish and/or retain an open shape of hand opening 140 (i.e., keep hand opening 140 open), thereby facilitating ease of entry/exit of the user's hand into and out of cavity 120.

While only one protective hand covering 100 is illustrated and described, it is understood that a pair of protective hand coverings 100 are provided for attachment or securing to both ends of handlebar 12 to cover or protect both hands of a rider of bicycle 10. While protective hand covering 100 is illustrated and described for use with bicycle 10, it is understood that protective hand covering 100 may be used with other handlebars or hand grips including, for example, handlebars or hand grips for motorcycles, scooters, strollers, wheelchairs, kayak paddles, etc.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

What is claimed is:

1. A protective hand covering to be attached to a handlebar, comprising:
a shell to cover a portion of the handlebar, the shell forming a cavity and having a cuff extending therefrom,
a break in the cuff to be closed to establish a first configuration of the protective hand covering,
the break in the cuff to be opened to establish a second configuration of the protective hand covering, and
the break in the cuff to be opened and the cuff to be folded to establish a third configuration of the protective hand covering.

2. The protective hand covering of claim 1, the break in the cuff provided along a medial side of the cuff.

3. The protective hand covering of claim 1, the break in the cuff extended from an opening of the cuff to a base of the cuff.

4. The protective hand covering of claim 3, the cuff to be folded along the base to establish the third configuration.

5. The protective hand covering of claim 1, the cuff to be folded along a circumferential seam extended substantially around the cuff to establish the third configuration.

6. The protective hand covering of claim 1, the shell including a medial seam, the break in the cuff extended from the medial seam.

7. A protective hand covering, comprising:
a shell defining a cavity; and
a cuff extending from the shell, the cuff having a split therein,
the cuff to have a closed configuration with the split closed, an open configuration with the split open, and a folded configuration with the split open.

8. The protective hand covering of claim 7, further comprising:
a fold line formed at a base of the cuff between the cuff and shell.

9. The protective hand covering of claim 8, the fold line comprising a circumferential seam extending substantially around the cuff.

10. The protective hand covering of claim 8, the split of the cuff extended from an opening of the cuff to the base of the cuff.

11. The protective hand covering of claim 7, the split of the cuff provided along a medial side of the cuff.

12. The protective hand covering of claim 7, the shell including a top panel and a bottom panel joined along a medial seam, and the split of the cuff extended from the medial seam.

13. The protective hand covering of claim 7, the cuff including a zipper along the split to selectively close and open the split.

14. A protective hand covering, comprising:
a shell forming a pocket for receiving a user's hand; and
a configurable cuff extending from the shell,
the configurable cuff to be closed to provide a first level of coverage to the user's hand, opened to provide a second level of coverage to the user's hand less than the first level of coverage, and folded to provide a third level of coverage to the user's hand less than the second level of coverage.

15. The protective hand covering of claim 14, wherein, with the first level of coverage, the configurable cuff is to fully encircle a forearm of the user.

16. The protective hand covering of claim 15, wherein, with the second level of coverage, the configurable cuff is to partially encircle the forearm of the user.

17. The protective hand covering of claim 14, wherein, to provide the second level of coverage, the configurable cuff is to be opened along a medial side thereof.

18. The protective hand covering of claim 17, wherein, to provide the third level of coverage, the configurable cuff is to be opened along the medial side thereof and folded.

19. The protective hand covering of claim 17, wherein, to provide the first level of coverage, the configurable cuff is to be closed along the medial side thereof.

20. The protective hand covering of claim 14, wherein, to provide the third level of coverage, the configurable cuff is to be folded along a circumferential seam between the shell and the configurable cuff.
